(19) United States
(12) Patent Application Publication
(10) Pub. No.: US 2007/0103729 A1
(43) Pub. Date: May 10, 2007

(54) Printing method and printing apparatus

(75) Inventors: Akira Yoda, Kanagawa-ken (JP); Masahiro Kubo, Kanagawa-ken (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/593,109

(22) Filed: Nov. 6, 2006

(30) Foreign Application Priority Data
Nov. 7, 2005 (JP) 321796/2005

(51) Int. Cl. G06K 15/00

(52) U.S. Cl. 358/1.18; 358/302

(57) ABSTRACT

In a method for printing an image on a printing medium having a memory device mounted on the medium, the position of the memory device on the printing medium is detected, and the position for printing the image on the printing medium is set based on the detected position of the memory device.

### BACKGROUND OF THE INVENTION

1. Field of the Invention

The present invention relates to a printing method and a printing apparatus. More specifically, the present invention relates to a printing method and a printing apparatus for printing an image on a printing medium having a memory device mounted thereon.

2. Description of the Related Art

Techniques for managing commodities using small memory devices called RF tag or IC chip are proposed. The memory device has an advantage that it can be mounted inside of a commodity package, since it allows contactless data read/write operation using a radio wave. Various types of memory devices have been developed ranging from those inexpensive and having various shapes to those semipermanently reusable without requiring a battery by obtaining the power from the antenna, and are widely used for various applications, as well as commodity management.

For example, an ID photo, which is a face image printed on a printing paper having a memory device like that described above embedded therein, is disclosed as described, for example, in U.S. Patent Application Publication No. 20030136851. In such ID photos, personal identification data for identifying individuals who apply for personal identification documents maybe registered in the memory device. In addition, forgeries of personal identification documents may be prevented by embedding the memory devices in the ID photos.

The specific method for performing printing on a printing paper having a memory device like that describe above, however, is not described in the U.S. Patent Application Publication No. 20030136851. Generally, the arrangement accuracy for embedding the memory device in a printing paper is not so high. Therefore, in the ordinary method in which the printing position is determined with reference to the end of the printing paper, it is not necessarily the case in which the image and the memory device are arranged in a desired positional relationship. This causes problems that the memory device locates outside of a predetermined area of the image even if trying to dispose it within the predetermined area, and it may locate in the cutting path or discarded portion of the printing paper when cutting the printing paper with reference to the image.

The present invention has been developed in view of the circumstances described above, and it is an object of the present invention to provide a printing method and a printing apparatus capable of arranging a memory device and an image in a desired positional relationship when printing the image on a printing medium having the memory device mounted thereon.

### SUMMARY OF THE INVENTION

The printing method of the present invention is a method for printing an image on a printing medium having a memory device mounted thereon. The method includes the steps of: detecting the position of the memory device on the printing medium; and setting the position for printing the image on the printing medium based on the detected position of the memory device.

The printing apparatus of the present invention is an apparatus for printing an image on a printing medium having a memory device mounted thereon. The apparatus includes: a detection means for detecting the position of the memory device on the printing medium; and a setting means for setting the position for printing the image on the printing medium based on the detected position of the memory device.

The setting means may set the position for printing the image such that the memory device locates in the periphery of the image. If the image is a face image, the setting means may set the position for printing the face image such that the memory device locates within the face of the face image, for example, in the center of the face, or may set the position of the face image such that the memory device locates within the area of the face image other than the face.

If the image is a face image, and the memory device has stored therein its own individual identification data, the printing apparatus of the present invention may further includes a linkage means for linking the individual identification data of the memory device, data of the face image, and individual identification data of the subject of the face image.

Further, if the image is a face image, the printing apparatus of the present invention may further includes a writing means for writing biological data of the subject of the face image into the memory device.

The referent of “memory device” as used herein means is a small data storage device which is mountable on a printing medium. Preferably, the memory device is a wireless chip, which is a contactless memory chip that allows data read/write operation using a radio wave. Specific examples of the memory device include RF (Radio Frequency) tag, ID tag, wireless tag, electronic tag, IC (Integrated Circuit) tag, IC chip, RFID (Radio Frequency Identification), transponder, and the like.

The referent of “biological data” as used herein means hand-related biological data, such as fingerprint, palm print, palm shape, finger-vein pattern, palm-vein pattern, and the like, or other biological data including voiceprint or the like. The referent of “biological data of the subject of the face image” as used herein means biological data of the subject of the face image other than the face thereof.

The printing method and apparatus of the present invention detects the position of a memory device on a printing medium, and sets the position for printing an image on the printing medium based on the detected position of the memory device. Thus, when printing an image on a printing medium having a memory device mounted thereon, the memory device and image may always be arranged in a desired positional relationship. This allows the memory device to be disposed reliably within a desired area of the image. Further, even if the printing medium is cut off with reference to the image, the memory device does not locate in the cutting path or discarded portion of the printing medium after cutting, so that the memory device may be prevented from being separated from the image when the printing medium is cut off.

Further, the printing method and apparatus of the present invention may set the position for printing an image such that a memory device reliably locates in the periphery of the image, which is difficult by the conventional method in which the image is printed without detecting the position of the memory device. Thus, the present invention has significantly advantageous effects compared to the conventional method.

Still further, if the image is a face image, and the position thereof is set such that the memory device locates in the center of the face of the face image, the forgery of the face image may be prevented, since the memory device needs to be peeled off in order to forge the face image and the restoration thereof is extremely difficult.

Further, if the image is a face image, the memory device has stored therein its own individual identification data, and the apparatus further includes a linkage means for linking the individual identification data of the memory device, data of the face image, and individual identification data of the subject of the face image, the created face image with the memory device may be used for personal authentication of the subject of the face image, and may also provide anti-counterfeit effects since the memory device includes individual identification data.

Still further, if the image is a face image, and the apparatus further includes a writing means for writing biological data of the subject of the face image into the memory device, the created face image with the memory device may be used for biometric authentication of the subject of the face image.

### BRIEF DESCRIPTION OF THE DRAWINGS

FIG. 1 is a schematic view of the printing apparatus according to an embodiment of the present invention.

FIG. 2 is an external view of the printing apparatus shown in FIG. 1.

FIG. 3 is schematic view of the printer shown in FIG. 1.

FIG. 4 is a functional block diagram of a relevant part of the printing apparatus shown in FIG. 1.

FIG. 5 is a flowchart for explaining the operation of the printing apparatus shown in FIG. 1.

FIG. 6 is a flowchart for explaining the operation of the printing apparatus shown in FIG. 1.

FIG. 7 is a drawing illustrating photographs with a memory device according to an embodiment of the present invention.

FIG. 8 is a drawing illustrating photographs with a memory device according to another embodiment of the present invention.

FIGS. 9A and 9B are drawings illustrating photographs with a memory device according to still another embodiment of the present invention.

FIGS. 10A and 10B are drawings illustrating photographs with a memory device according to further embodiment of the present invention.

### DESCRIPTION OF THE PREFERRED EMBODIMENTS

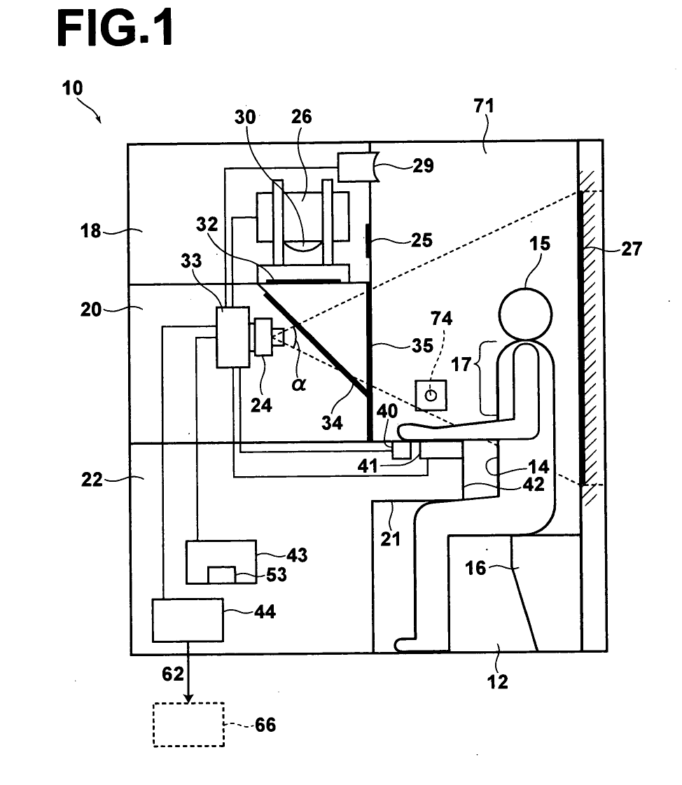

Hereinafter, the printing apparatus and a printing method according to an embodiment of the present invention will be described with reference to accompanying drawings. FIG. 1 is a schematic view of the printing apparatus 10 according to the present embodiment. The printing apparatus 10 is an apparatus for obtaining a face image and biological data of a user, and printing the obtained face image on a printing paper with a memory device as an ID photo. The apparatus 10 has a cuboid enclosure having a height of approximately 2.0 m with a width of approximately 1.4 m. An external view of the apparatus 10 is shown in FIG. 2 as an example.

As shown in FIG. 1, the apparatus 10 includes a imaging compartment 12 having a width of around 75 cm. A user 14 sits on a chair 16 in the imaging compartment 12 to perform imaging.

The portion of the imaging apparatus 10 other than the imaging compartment 12 is divided into an upper section 18, middle section 20, and bottom section 22 having a desk 21. A digital camera 24 and a controller 33 are installed in the middle section 20, and a printer 43 is installed in the bottom section. The controller 33 controls the overall operation of the printing apparatus 10, including control of the digital camera 24 and printer 43.

The lens field angle α of the digital camera 24 is wide enough to cover the range from around 60 cm to around 170 cm in height on a rear wall 27 of the imaging compartment 12. Consequently, when the user 14 sits on the chair 16, at least a head region 15 and a chest region 17 are reliably covered, which allows imaging independent of the height of the body of the user 14.

A lighting unit 25, a CRT display 26, and a speaker 29 are installed in the upper section 18, which are connected to the controller 33.

The CRT display 26 is capable of displaying a motion image and a still image outputted from the controller 33. The display screen 30 of the display 26 is directed downward, and the display content is projected onto a half mirror 34 in the middle section 20 through a hollow boundary face 32 between the upper section 18 and the middle section 20.

According to the inclined half mirror 34 disposed between the camera 24 and the user 14, a portion of the light from the display 26 and the user compartment 12 is reflected to each other. A portion of the light from the imaging compartment 12 is transmitted through the mirror 34 and propagates to the camera 24, but the light from the side of the camera 24 is blocked and does not reach the imaging compartment 12. Consequently, the user 14 may view the projected content on the half mirror 34 through a glass window 35, but may not recognize the camera 24. But the camera 24 may record an image of the user 14 with the light propagated to the camera 24 from the imaging compartment 12 through the half mirror 34.

The lighting unit 25 is installed for illuminating the imaging compartment 12 to provide sufficient luminance for imaging, and the speaker 29 is installed to provide voice operation guidance to the user 14.

A fingerprint obtaining section 40, an operation touch panel 41, a printer 43, and a modem 44 are provided in the bottom section 22, which are connected to the controller 33. The fingerprint obtaining section 40 and operation touch panel 41 are accommodated in the desk 21.

The fingerprint obtaining section 40 is a semiconductor fingerprint obtaining section constructed to automatically obtain fingerprint digital data when a predetermined area of the fingerprint obtaining section 40 is touched by a finger.

The touch panel 41 is a device for outputting signals to the controller 33 according to the operational instruction by the user 14. The touch panel 41 may switchably display a data entry screen in which the user may enter data and an operational instruction entry screen in which the user may enter operational instructions. A keyboard is displayed on the data entry screen, and an imaging button for giving an instruction to take a face image and a selection button for selecting a face image to be printed by the printer 43 are displayed on the operational instruction entry screen.

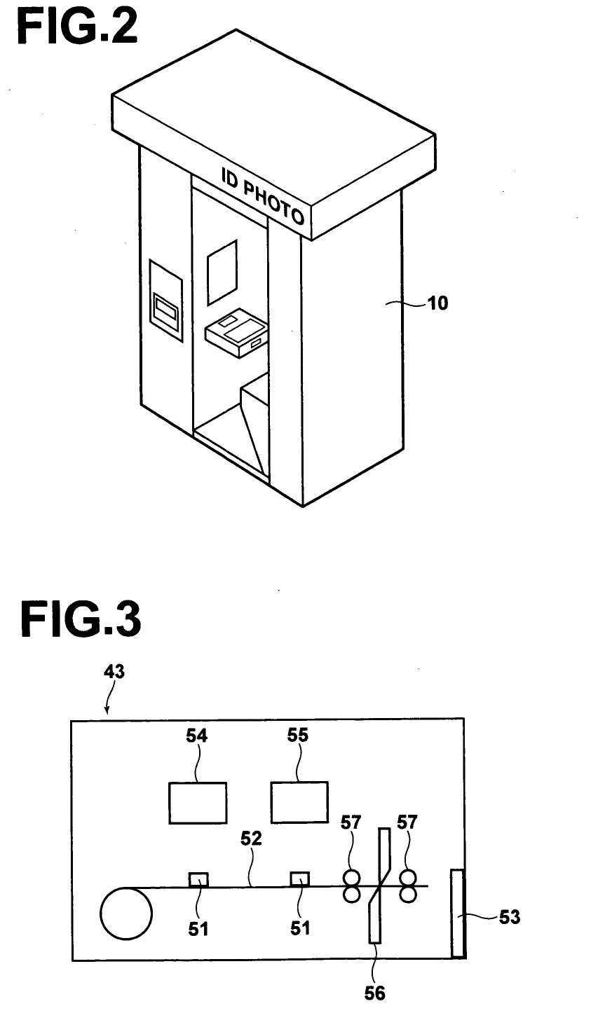

The printer 43 prints the selected image as a photograph on a printing paper 52 with a memory device 51 mounted thereon, which is a printing medium, and outputs the photograph from an outlet 53. FIG. 3 illustrates a schematic view of the printer 43. The printer 43 includes: a reader/writer 54 for detecting the position of the memory device 51, and performing data read/write operation to the memory device 51; a printing section 55 for printing an image on the printing paper 52; a cutter 56 for cutting the printing paper 52; and a roller 57 for feeding the printing paper 52 in roll form.

In FIG. 3, the memory device 51 is depicted in an enlarged form in which it is protruding from the surface of the printing paper 52 for clarity. In actuality, however, the memory device 51 has a microscopic size, and is embedded in the printing paper 52 in a predetermined density so that one or more memory devices are included in a printed image. The memory device 51 is a wireless chip that allows data read/write operation using a radio wave. For example, an RF tag may be used as the memory device 51. Each memory device 51 has a unique ID stored therein, which is an own individual identification data written therein during the manufacturing process. The operation of the printer 43 will be described in detail later.

The modem 44 is a data transfer means for transferring various data to a predetermined place, for example, a management center 66 through a communication line 62 according to the instruction from the controller 33.

In FIG. 1, the inside of the upper section 18, middle section 20, and bottom section 22 is shown visible for convenience. In actuality, however, the inside is hidden by a wall and invisible to the user other than the fingerprint obtaining section 40, touch panel 41, and outlet 53 of the printer 43. Further, in actuality, further mechanisms including a coin slot, a payback slot, and the like are also provided in the bottom section 22, but they are omitted in FIG. 1 for clarity.

A monitoring camera 74 for continuously recording the user 14 is provided on a side wall 71 of the apparatus 10. The monitoring camera 74 has a wide field angle and may obtain a monitor image that includes both the hand and face of the user recorded at the same time. The monitoring camera 74 is attached to a position on the side wall 71 approximately 10 cm higher than the position corresponding to the side of the finger print obtaining section 40. Preferably, for example, an infrared LED (Light Emitting Diode) camera is used as the camera 74. The monitor image recorded by the monitoring camera 74 is outputted to the controller 33.

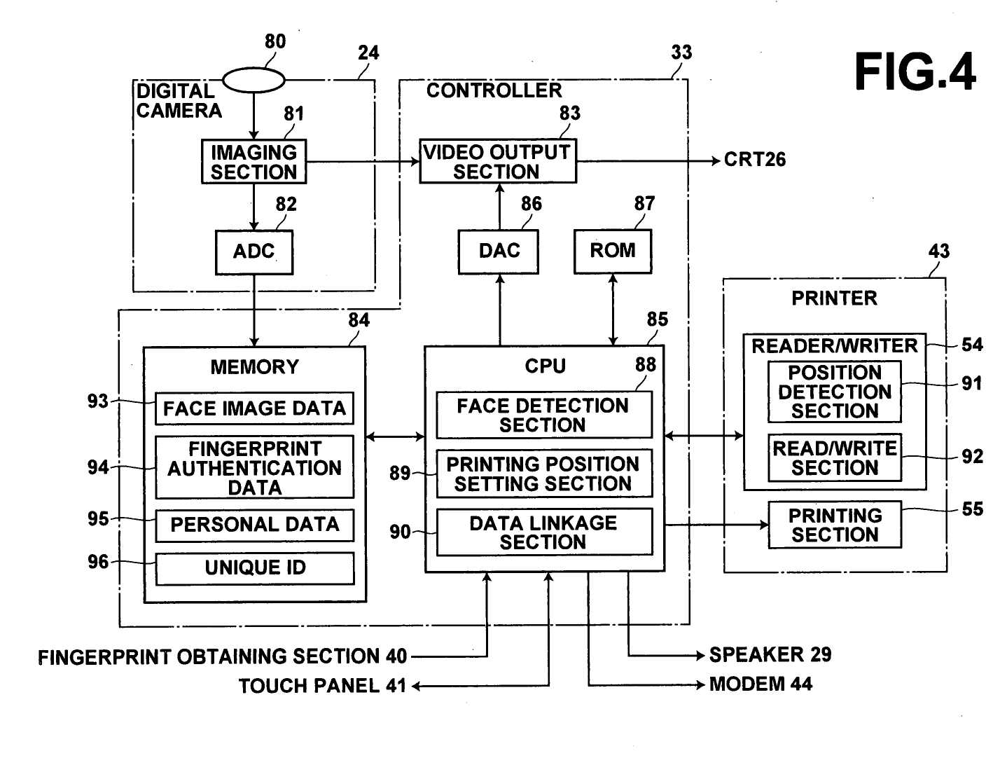

FIG. 4 is a functional block diagram of the digital camera 24, controller 33, and printer 43 shown in FIG. 1. The digital camera 24 includes an optical lens 80, imaging section 81, and an A/D converter (Analog/Digital Converter, ADC) 82. The controller 33 includes a video output section 83, a memory 84, a CPU (Central Processing Unit) 85, a D/A converter (Digital/Analog Converter, DAC) 86, and a ROM (Read Only Memory) 87. Although, the CPU 85 has many functions, FIG. 4 shows only a face detection section 88, a printing position setting section 89, and a data linkage section 90, which are the relevant parts of the present invention. The reader/writer 54 of the printer 43 includes a position detection section 91 and a read/write section 92.

In the digital camera 24, the optical lens 80 focuses the image of the subject 14 on the light receiving surface of an imaging section 81 by receiving light from the subject 14. As for the imaging section 81, for example, CCD (Charge Coupled Device) may be used. Image signals photoelectrically converted by the imaging section 81 are outputted to a video output section 83 of the controller 33.

Generally, the video output section 83 sends the image signals received from the imaging section 81 to the CRT display 26 directly through the output terminal. Thus, the motion image of the user 14 is captured by the camera 24 and outputted, then displayed on the CRT 26, and finally reflected by the half mirror 34 to return to the user 14. Hereinafter, the returning of the motion image directly to the user in the manner as described above is referred to as video through. The user 14 may observe self motion image returned by video through in real time prior to imaging.

The image signals outputted from the imaging section 81 may also be outputted to the A/D converter 82. When a face image is recorded, the image signals, which are analog signals, are converted to digital image signals by the A/D converter 82, and the digital image signals are stored in the memory 84 of the controller 33 as face image data 93.

The CPU 85 is connected to the A/D converter 82, memory 84, and D/A converter 86 to control them. When imaging is performed, the CPU 85 sends a conversion command to the A/D converter 82 to cause it to perform A/D conversion on the motion image on a frame basis. The CPU 85 may fetch the digital image signals digitized and stored in the memory 84 to perform various image processing, and then store them in the memory 84 again.

The CPU 85 may output a digital still image after performing image processing to the D/A converter 86 to cause it to perform D/A conversion on the digital still image and to send the analog still image to the video output section 83. Here, the CPU 85 may control the video output section 83 to output the analog still image instead of the analog motion image returned by video through. In this way, the recorded and image processed still images may be presented to the user. Further, the analog still image signals and motion image signals may be outputted either in color or black-and-white format.

The CPU 85 may cause the CRT 26 to display the recorded and processed images by laying out them freely. Further, it may also cause the CRT 26 to display a simple animation by sending a plurality of still images stored in the memory 84 in advance on a frame by frame basis, as well as outputting the recorded image. Still further, it may freely output graphics through the video output section 83, so that a message directed to the user 14 may be displayed on the CRT 26.

The CPU 85 causes the CRT 26 to display the recorded still face images of the user 14 after image processing is performed thereon, and an indicator for use by the user 14 to select the face image to be printed. The face detection section 88 of the CPU 85 detects the face in the selected face image, and further detects the center of the face.

The CPU 85 is also connected to the printer 43. The position detection section 91 in the reader/writer 54 of the printer 43 is a detection means for detecting the position of the memory device 51 on the printing paper 52, and sends the detected position to the CPU 85. The read/write section 92 in the reader/writer 54 of the printer 43 is a section having functions of reading means and writing means. It reads out a unique ID 96 stored in the memory device 51 and sends it to the CPU 85, or writes data into the memory device 51 according to the instruction from the CPU 85. The CPU 85 stores the unique ID 96 in the memory 84.

The printing position setting section 89 of the CPU 85 is a setting means for setting the position for printing the face image on the printing paper 52 based on the center of the face detected by the face detection section 88 and the position of the memory device 51 detected by the position detection section 91 of the printer 43. It sends the settings to the printing section 55 of the printer 43. The printing section 55 prints the image on the printing paper 52 based on the settings received from the setting means.

The CPU 85 is further connected to the finger print obtaining section 40 and touch panel 41. The CPU 85 determines if the fingerprint data obtained by the fingerprint obtaining section 40 are applicable to fingerprint authentication. If the data are determined to be applicable to fingerprint authentication, it stores the data in the memory 84 as fingerprint authentication data 94. The CPU 85 also stores personal data 95 of the user 14 inputted from the touch panel 41.

The data linkage section 90 of the CPU 85 is a linking means for linking the face image data 93, which are the data of the face image of the user 14 obtained by the digital camera 24, fingerprint authentication data 94, personal data 95, and unique ID 96 of the memory device 51. The CPU 85 sends an instruction to the reader/writer 54 to cause it to write the linked data into the memory device 51. In addition to the data described above, the CPU 85 may further link the unique identification number of the printing apparatus 10, date and time data of imaging, and monitor still image data obtained by the monitoring camera 74. Further, the CPU may send the linked data to the remote management center 66 through the modem 44 and communication line 62.

The linking of the data may be performed by any method. For example, a name maybe given to the face image data using the personal data. Alternatively, text data may be recorded in the header section of the digital image data, and store them in the memory 84 as a unit. By linking personal data to digital image data in the manner as described above, digital data of a face image that self-identifying to whom it belongs may be created.

Further, the CPU 85 receives operational instructions from the touch panel 41, and performs the processes according to the instructions given by the user 14. The CPU 85 is also connected to the speaker 29, and may output voice signals provided in advance to give appropriate operational guidance to the user 14 in speech for each operation step.

The CPU 85 is further connected to the ROM 87. The ROM 87 stores at least a plurality of image processing programs and requirement specifications of ID photos. The requirement specifications include data related at least to the size of the photograph to be printed, the size and location of the head in the photograph, positional relationship between the memory device 51 and image to be printed. The CPU 85 accesses the ROM 87 to read the programs and requirement specifications of ID photos as required, and performs processing on the still image fetched from the memory 84 in order to provide a photograph that conforms to the requirement specifications.

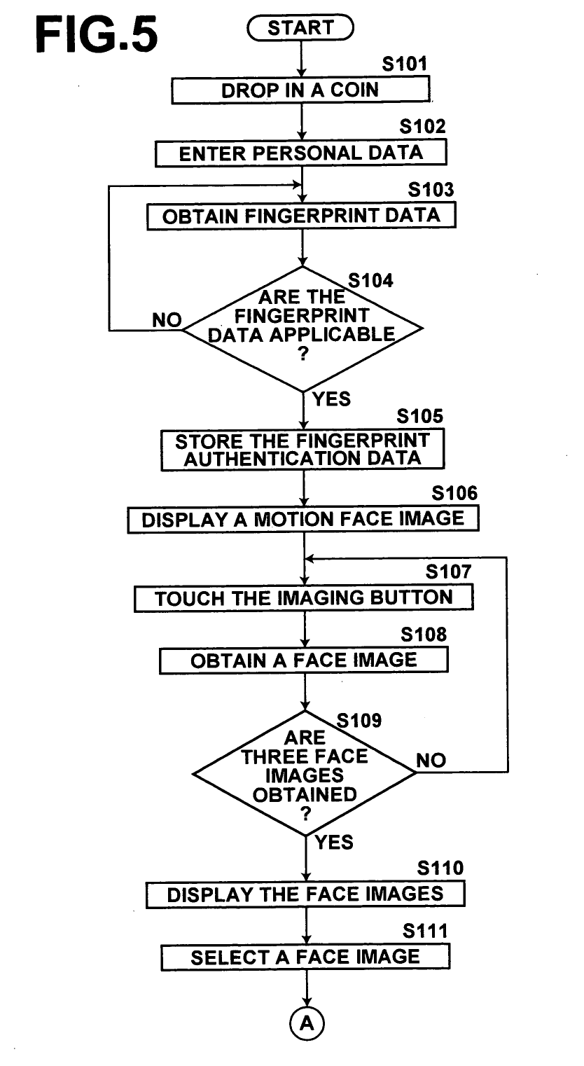

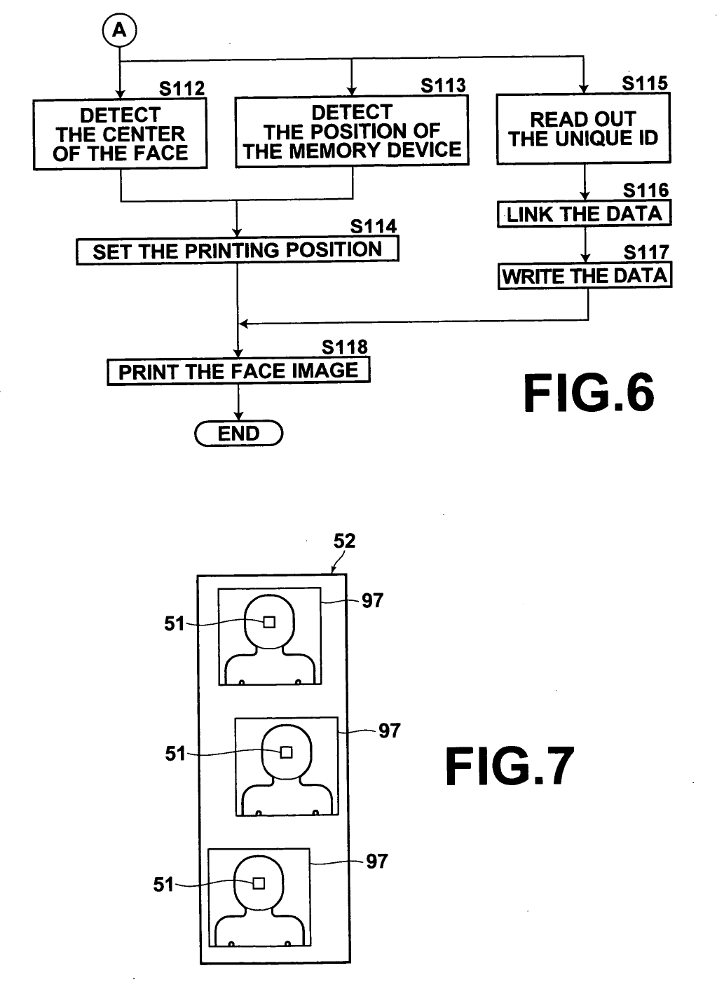

The operation of the printing apparatus 10 of the present invention constructed in the manner as described above will now be described. A flowchart for explaining the process of the printing apparatus 10 of the present invention is shown in FIGS. 5 and 6. Most of the steps to be described hereinafter are prompted by the voice message from the speaker 29. First, the user 14 drops in a coin (Step 101). This activates the printing apparatus 10. Thereafter, the personal data 95 including the user name, resident resister code number or a passport number, and the like are inputted from the touch panel 41 on which the data entry screen (keyboard) is displayed (Step 102). The personal data 95 is used as individual identification data.

Then, in the fingerprint obtaining section 40, fingerprint digital data are obtained from the right and left forefingers of the user (Step 103). The controller 33 extracts minutia points from these fingerprint data, and determines if sufficient minutia points required for the fingerprint authentication are obtained, i.e., if these fingerprint data are applicable to the fingerprint authentication (Step 104). If these fingerprint data are determined not to be applicable to the fingerprint authentication, the process returns to the Step 103, and prompts the user to obtain the digital fingerprint data again. If the fingerprint data are determined to be applicable to the fingerprint authentication, the process proceeds to Step 105, and these fingerprint data are stored in the memory 84 of the controller 33 as fingerprint authentication data (Step 105).

Thereafter, a motion face image of the user performing imaging using the digital camera 24 is displayed on the CRT display 26 by video through (Step 106). Here, the touch panel 41 is switched to the operation entry screen. By observing the own face image displayed on the CRT display 26, the user touches the imaging button at a desired timing (Step 107). Through the imaging instruction, a still image of the face is obtained by the digital camera 24 and stored in the memory 84 of the controller 33 as the face image data 93 (Step 108).

Then, a determination is made if three face images are stored in the memory 84 (Step 109). If the determination result is negative, the process returns to Step 107 to prompt the user to touch the imaging button again, and if the determination result is positive, the three face images are displayed on the CRT display 26 (Step 110). The user selects preferred face image data through the selection button (Step 111).

The face detection section 88 of the controller 33 detects the face in the selected face image, and further detects the center of the face (Step 112). The detection of the center of the face may be performed by detecting the contour of the face using any known method such as edge detection or the like, and determining the center, or by detecting the positions of the parts of the face, such as the eyes, nose, mouth, ears, and the like, by any known image recognition method, and determining the center with reference to the positions of the parts.

In parallel to the process in Step 112, the position detection section 91 in the reader/writer 54 of the printer 43 detects the position of each memory device 51 in the printing paper 52 (Step 113), and sends the detected position to the CPU 85 of the controller 33. The printing position setting section 89 of the CPU 85 sets the printing position of the face image (Step 114), and gives instruction to the printing section 55 of the printer 43.

The read/write section 92 of the reader/writer 54 reads out the unique ID 96 of the memory device 91 located in the area where the face image is to be printed (Step 115), and sends it to the CPU 85 of the controller 33. The data linkage section 90 of the CPU 85 links the personal data 95 inputted in Step 102, fingerprint authentication data 94 stored in Step 105, face image data 93 selected in Step 111, and unique ID 96 of the memory device 51 read out in Step 115 to each other (Step 116).

Then, the CPU 85 gives an instruction to the read/write section 92 of the reader/writer 54 to cause it to write these linked data into the memory device 51 (Step 117). In the mean time, when the user drops in a coin in Step 101, the recording of the monitor image by the monitoring camera 74 is initiated, and the monitor image is outputted to the controller 33. Thus, the monitor still image when the finger print data was obtained, unique identification number of the printing apparatus 10, and the date and time of imaging may also be linked in addition to the data described above. Further, the CPU 85 may store the linked data in the memory 84 for a predetermined period, send them to a predetermined place, for example, the remote management center 66 through the modem 44 and communication line 62, or print out. The data to be linked or written into the memory device 51 are not limited to these data described above, and any type of data may be selected for this purpose.

The management center 66 retains the monitor images which may be observed on a monitor in real time. Alternatively, the monitor images may be analyzed by a computer or the like, and an alert may be issued or operation of the printing apparatus 10 may be automatically terminated if something wrong happens in the monitor image. The monitor still image data may include an entire image and an enlarged portion thereof where the hand is imaged. When monitoring the monitor images in the management center 66 in the manner as described above, monitor images in animation may also be monitored.

When the processes in Step 114 and Step 117 are completed, the printing section 55 of the printer 43 prints the face image on the instructed position (Step 118), the printing paper 52 is cut off by the cutter 56 at a predetermined position, and the face photograph with a memory device 51 is outputted from the outlet 53.

FIG. 7 illustrates examples of face photographs 97 with a memory device 51 created in the manner as described above. These face photograph examples are obtained by printing the face images on the printing paper 52 with memory devices 51 mounted in the center thereof in the width direction at predetermined intervals along the longitudinal direction of the paper 52 such that each of the memory devices 51 is arranged at the center of each of the face image. Even when the arrangement accuracy of the memory devices 51 is not so high, and the distance of the three memory devices 51 from the right or left edge of the printing paper 52 differs with each other, each of the memory devices 51 may always be arranged in the center of each of the three face photographs 97 as shown in FIG. 7.

As is evident from the description above, in the printing apparatus and printing method of the present embodiment, the position of a memory device 51 in a printing paper 52 is detected, and the face image is printed thereon based on the detected position. Thus, a face photograph with a memory device, in which the memory device and the face image are arranged in a desired positional relationship, maybe created reliably. This ensures that a memory device is arranged within a desired area of an image, which may prevent the case in which the memory device locates in the cutting path or discarded portion of the printing paper and separated from the image. Here, when the memory device is disposed in the face, the memory device needs to be peeled off in order to forge the face photograph and the restoration thereof is extremely difficult so that such forgery may be prevented.

Further, personal data, fingerprint authentication data, and face image data of a user, unique ID of a memory device 51 and the like are stored in the memory device 51, so that the created face photograph with the memory device may be used for personal authentication, and forgery of the photograph may be prevented since the memory device 51 includes individual identification data. Further, the created face photograph may be used for biometric authentication since the memory device includes fingerprint authentication data.

Still further, when obtaining fingerprint data of a user 14, a monitor image that includes both the face and hand of the user 14 recorded at the same time is obtained, so that counterfeiting switching of the user 14 and fraudulent acquisition of hand-related biological data may be prevented.

Further, if the recorded monitor images are retained for a predetermined period, they may be observed as required. If an enlarged image of the hand of a user is obtained, fraudulent acquisition of fingerprint data may be detected by observing the monitor images, so that fraudulent acquisition of fingerprint data may be prevent even more reliably.

The positional relationship between the memory device and face image is not limited to the example shown in FIG. 7, and may be set arbitrarily. For example, a method for setting the memory device 51 within a face regardless of the position within the face, or a method for setting the memory device 51 at the region other than the face may also be feasible. Further, the memory device 51 may locate in the periphery within the image, or the periphery outside of the image.

FIG. 8 illustrates an example case in which each of the memory devices 51 is arranged at a corner section of each of the face images. The illustrated example indicates the case in which face photographs 197 are obtained by printing the face images using the printing method of the present invention on the printing paper 152 with memory devices 51 mounted in the position adjacent to the left end of the paper at predetermined intervals along the longitudinal direction thereof such that each of the memory devices 51 is arranged at the upper left of each of the face images 197. Even when the arrangement accuracy of the memory devices 51 is not so high, and the distance of the three memory devices 51 from the left edge of the printing paper 52 differs with each other, each of the memory devices 51 may be arranged at the upper left corner of each of the three face photographs 197 as shown in FIG. 8.

Use of the printing method of the present invention, in which an image is printed after the position of the image is set based on the position of the memory device, allows the memory device and the image to be arranged in desired positional relationship, and the arrangement accuracy of the memory devices on the printing paper to be relaxed. In the conventional method, the memory devices greater in number than the images are arranged in shorter intervals than the images in order to ensure that one or more memory devices locate invariably within a single image, taking into account of the misalignment between the memory device and image. This has resulted in unused memory devices. On the other hand, in the printing method of the present invention, one memory device may be invariably disposed within a single image with a number of memory devices corresponding to the number of images, so that no memory device is wasted.

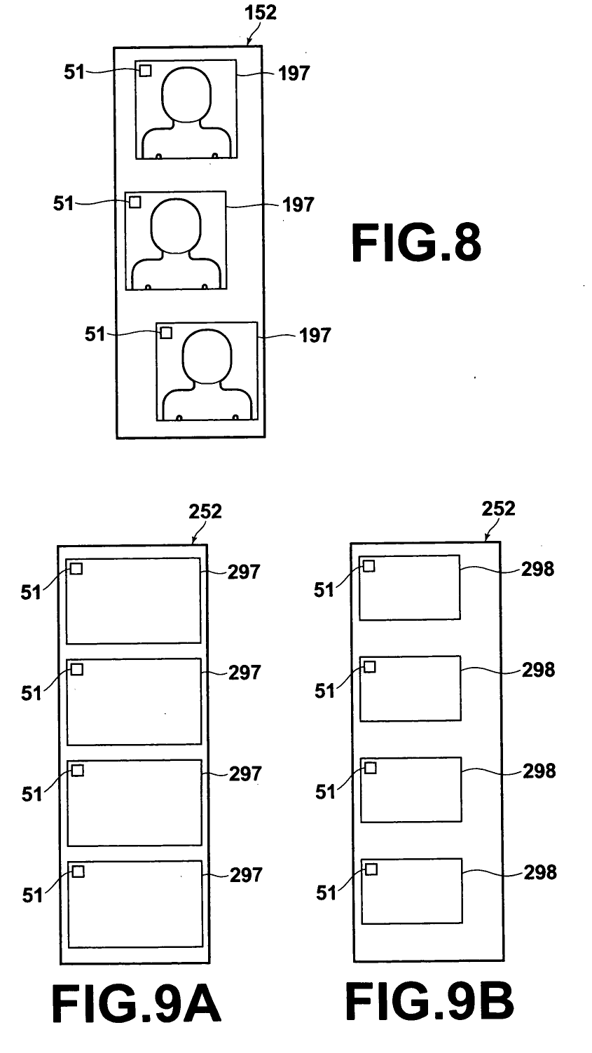

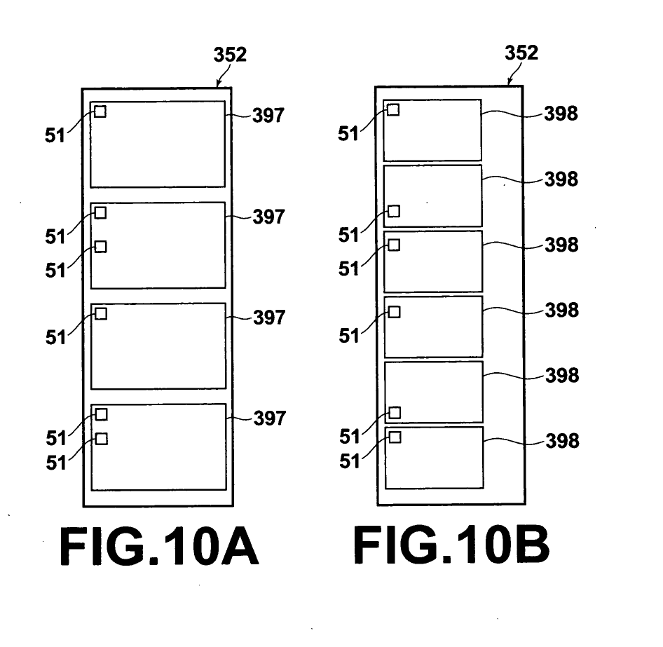

Further, even in a case where a plurality of sizes is used for photographs to be printed, use of the printing method of the present invention allows photographs with a plurality of different sizes may be created using the same type of printing paper. Hereinafter, a specific example will be described with reference to FIGS. 9A, 9B, 10A and 10B.

FIG. 9A and 9B illustrate an example case in which a printing paper 252 having memory devices 51 mounted thereon at intervals corresponding to the size of the largest photograph 297 is used. Although, the size of the photographs 297 shown in FIG. 9A differs from the size of the photographs 298 shown in FIG. 9B, photographs, each having a memory device 51 in the upper left may be created by the application of the printing method of the present invention. In this example, the memory devices 51 are mounted at intervals according to the size of the largest photograph 297, so that only the number of memory devices corresponding to the number of the photographs is required.

FIG. 10A and 10B illustrate an example case in which a printing paper 352, on which four large photographs 397 or six small photographs 398 are printed within a predetermined length with memory devices mounted thereon such that one or more memory devices are disposed in each photograph, is used. Although, the size of the photographs 397 shown in FIG. 10A differs from the size of the photographs 398 shown in FIG. 10B, one or more memory devices 51 may be disposed in each photograph, and at the same time the blank space of the printing paper 352 may be minimized by the application of the printing method of the present invention.

In the present embodiment described above, the image position is set for printing based on the position of the memory device. But the image orientation as well as the image position for printing may be set based on the position of the memory device. For example, if the position where the memory device is to be positioned is predetermined, for example, in the center, upper left, upper right, bottom left, or bottom right of the image, or the like, the image orientation and position may be set such that the memory device is disposed at a desired position after detecting the position of the memory device. If the subject is a person, the position of the eyes and mouth may be known by any known image recognition method, so that the vertical of the image may be detected and the orientation of the image may be set for printing.

In the present embodiment, the description of the present invention has been made with reference to a printing apparatus including an imaging compartment and a digital camera, which obtains a face image and biological data of a user, and prints the obtained face image, as an example, but the present invention is not limited to this. The printing apparatus of the present invention may be a printing apparatus without the means for obtaining image or biological data.

In the present embodiment, the description has been made of a case in which the image is a face image. But, the present invention is not limited to this, and may be applied to images of different subjects. Further, the position of the memory device on the printing paper, positional relationship between the image and memory device, and the number of memory devices included in the image are not limited to the example described above, and may be set arbitrarily. Still further, the data written into the memory device are not limited to the example described above, and any data may be written therein, or not necessarily be written therein.

In the present embodiment, the description has been made of a case in which a printing paper in roll form is used, but the paper form is not limited to the roll form, and a cut form of a predetermined size may also be used. The printing medium that may be used in the present invention is not limited to the printing paper, and any medium may be used as long as it is printable, such as stationery paper, cloth, or the like. Further, in the present embodiment, the description has been made with reference to a printing apparatus that prints an image as a photograph, but the present invention is not limited to this, and may be applied to an apparatus that uses a laser printer, an inkjet printer, or the like.

What is claimed is:

1. A printing method for printing an image on a printing medium having a memory device mounted thereon, the method comprising the steps of:
detecting the position of the memory device on the printing medium; and
setting the position for printing the image on the printing medium based on the detected position of the memory device.

2. A printing apparatus for printing an image on a printing medium having a memory device mounted thereon, the apparatus comprising:
a detection means for detecting the position of the memory device on the printing medium; and
a setting means for setting the position for printing the image on the printing medium based on the detected position of the memory device.

3. The printing apparatus according to the claim 2, wherein the setting means sets the position for printing the image such that the memory device locates in the periphery of the image.

4. The printing apparatus according to the claim 2, wherein:
the image is a face image; and
the setting means sets the position for printing the face image such that the memory device locates in the center of the face of the face image.

5. The printing apparatus according to the claim 2, wherein:
the image is a face image, and the memory device has stored therein its own individual identification data; and
the apparatus further comprises a linkage means for linking the individual identification data of the memory device, data of the face image, and individual identification data of the subject of the face image.

6. The printing apparatus according to the claim 2, wherein:
the image is a face image; and
the apparatus further comprises a writing means for writing biological data of the subject of the face image into the memory device.
